(19) United States
(12) Patent Application Publication
(10) Pub. No.: US 2002/0152402 A1
(43) Pub. Date: Oct. 17, 2002

(54) Personalized visitor pages

(76) Inventors: Ofer Shem Tov, Ramar Gan (IL); Ariel Rabban, Livingston, NJ (US); Gur Kimchi, New York, NY (US); Omer Luzzatti, New York, NY (US)

Correspondence Address: KATTEN MUCHIN ZAVIS ROSENMAN, 575 MADISON AVENUE, NEW YORK, NY, 10022-2585, US

(21) Appl. No.: 09/778,467

(22) Filed: Feb. 7, 2001

(51) Int. Cl. H04L 9/32

(52) U.S. Cl. 713/201

(57) ABSTRACT

A method to allow Internet service subscribers to expose a person-specific personalization of their “visitor web pages”. This service allows a subscriber to build a dedicated web page that is specifically assembled for another person. A visitor, upon accessing the web page, has the capability to review static and dynamic information or to call the subscriber using multimedia communications such as Voice-over-IP or send the subscriber information. The page may contain information that is made available only to the subscriber's family, such as the current active policy of the subscriber and the phone number that is closest to him. Such information is made available via the subscriber's policy.

### BACKGROUND OF THE INVENTION

1. Field of Invention

The present invention relates generally to the field of personalized web pages. More specifically, the invention relates to a method to allow Internet service subscribers to expose a person-specific personalization of their “visitor web pages”.

2. Prior Art

Today's world finds a plethora of communication options. In addition, the explosion of electronic information available has led many manufactures, suppliers, businesses and users to seek new, better and different methods of connecting, interfacing, and managing such. New solutions have led to differing hardware, software and communications standards and variations. However, managing these devices has become an ever changing and evolving task. Use of the Internet to manage non-Internet communication sources is one area yet to be fully developed.

Telephony devices, such as telephones (e.g., traditional wired, wireless, WAP, PCS and cellular), wireless handhelds (e.g., PDAs, pocket-PCs, laptops), pagers and web-enabled devices (e.g., Internet appliances, wireless handhelds) have given users many choices. With choices come decisions on which device to use, at which device and by what format an individual can be reached, what is the best way to be reached, which way is the least likely to be successful, etc. Some in the prior art have looked to ways of managing access to multiple devices. Two examples include unified or one number solutions; a few examples of such are described below. In these references the object appears to give persons wishing to make future contact with the end user a single portal of ingress, i.e. a single telephone number to contact a user's cell phone, pager and home or business phone. These systems then coordinate the actual connection to the end user.

U.S. Pat. No. 5,454,032, to Pinard et al., provides for a Method Of Establishing Communication Link To One Of Multiple Devices Associated With Single Telephone Number. Pinard et al. enable a user to designate a plurality of devices which will be contacted upon a caller dialing a single telephone number. A table is stored at the central office (CO) designating the device equipment identifiers for the common number. When the number is called, each of the devices is contacted simultaneously, an off-hook detected at one of the devices and the remaining devices ringing terminated.

U.S. Pat. No. 5,963,864, to O'Neil et al., provides for a Method And System For Automatically Connecting Telephone Calls To Multiple Devices Having Different Directory Numbers. O'Neil et al. appear to enable connection to either a home/business number and separate wireless number or both by calling either number. As with Pinard et al., both devices are contacted simultaneously.

U.S. Pat. No. 5,329,578, to Brennan et al., provides for a Personalized Communication Service With Mobility Manager. Brennan et al. teach of a personal agent for managing incoming calls. Calls to a personal number assigned to a subscriber are handled according to a service profile provided by the subscriber.

Whatever the precise merits, features and advantages of the above cited references, none of them achieve the Internet solution of personalized access to web pages, which in one embodiment, reveal telephony device availability and access methods.

### SUMMARY OF THE INVENTION

A method and system to give Internet service subscribers a way to expose a person-specific personalization of their “visitor web pages”. This service allows a subscriber to build a dedicated web page that is specifically assembled for another person. The personalized web page contains various combinations of static and dynamic information. Static information may contain name, address, e-mail, office party. Dynamic information may contain personalized messages, the name of the current active policy of the subscribers (usually in a format of location ‘at a meeting’, ‘at home’, ‘out of reach’ etc.), the current availability of the subscriber and the communications access methods. A visitor is given a dedicated level of access by the subscriber. Visitors to a site are given a level specific entry solution such as: password, URL, phone number, code, logging in on a guest web page, a visitor gives their name and the page requests the visitor to fill-in a box with additional information, biometrics (e.g., recognition of thumbprint, smartcard bio, voice, etc.) or other method of differentiation. Upon recognizing the visitor's level, a web page with information deemed appropriate by the subscriber is revealed. Levels of access include, for example, family, friends, business associates, anonymous, etc. Any number of levels or groupings of visitors are implemented based on a subscriber directed profile (policy).

A subscriber's policy is programmed by the subscriber, using a web interface (using HTML, XML, JavaScript, DHTML and other proprietary technologies). Such policy allows the subscriber to decide who has access to his personal information and who can call him or send him messages, in what time and to which device (routing policy). His personal information may include address, name, current policy name, current availability status. His routing policy may route the media (e.g. audio/video calls, messages) differently according to the caller/sender level of access, the time of the call and various other parameters. For example, if the subscriber's mother is trying to call him between 2 pm to 4 pm, the call will be routed first to his mobile phone and then (if busy or no-answer) to his office phone. Other callers will be routed to his voice mail. Combining multiple rules may create more complex policy profiles.

The visitor page may be thought of as a personalized web-based business card that can also reach (e.g. call, messages) the owner of the business card (i.e. the subscriber), and is personalized to the specific holder of the business card (i.e. the visitor).

### BRIEF DESCRIPTION OF THE DRAWINGS

FIG. 1 illustrates a subscriber flow diagram of the present invention.

FIG. 2 illustrates a system flow diagram of the present invention.

FIG. 3 illustrates a hierarchical level structure.

FIGS. 4a-4d collectively illustrate templates to build a subscriber's policy.

FIG. 5 illustrates an iconic based illustration of availability.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

A personal visitor page is assembled by creating a private area in the subscriber's web pages that is personalized. The page is optionally protected using a username and password, and which contain specific information tailored, by the subscriber to the specific visitor. A visitor page inherits the decision-making enabled by the subscriber's policy. Visitors to the subscriber's web pages will view a personalized version, based on their designated level of access. The personal user page may contain personal static information, personal dynamic information, such as the subscriber current active policy and his current availability status. In addition, operations (such as audio/video calls, sending messages) will be routed in accordance to the subscriber's policy and his current active devices.

The subscriber's guest page directs three main target groups:

1) For general purposes, anyone can visit the general guest page.

2) The subscriber can create guest pages for individual visitors that are not necessarily subscribers (such as Joe's father). The subscriber himself creates the guest and his password and sends the URL (e.g.) to his father. Be aware that the authentication is built in the URL itself.

3) Subscribers for whom the user did not create a specific page (with password) can Login using their own alias in the Subscriber's site (or if they go from their own site, the system already knows their identity).

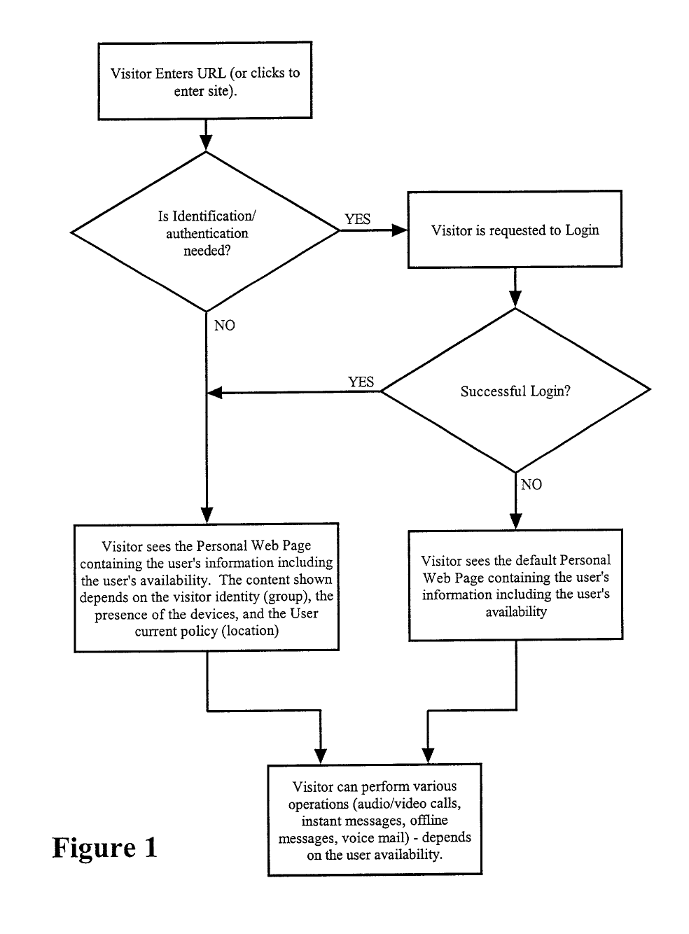

FIG. 1 illustrates a flow diagram of the present invention. A visitor to a subscriber's web page enters a URL or clicks to enter the site. Based on the subscriber's policy, a determination is made as to whether identification is needed. If identification is needed, a visitor is requested to logon using standard Id and password techniques. If the login is not successful the visitor will be directed to a “default personal web page” based on a default level designation. The default page will comprises at least basic subscriber information and availability (e.g., receiving text messages only). The visitor can perform various operations, such as audio/video calls, instant messaging, offline messages, e-mail, voice mail, conference calls, etc.

If the login is successful, the visitor views a personalized web page according to their level of access. The content is based on the visitor's identity (group belonging to), the presence of any devices (e.g., cell phone, laptop, handhelds) and the subscriber's policy. As with the default page, the visitor can perform various operations, such as audio/video calls, instant messaging, offline messages, voice mail, setting a conference call, etc. The operations, such as placing a call, or sending a message, will be routed in accordance to the subscriber's policy and the presence of the devices.

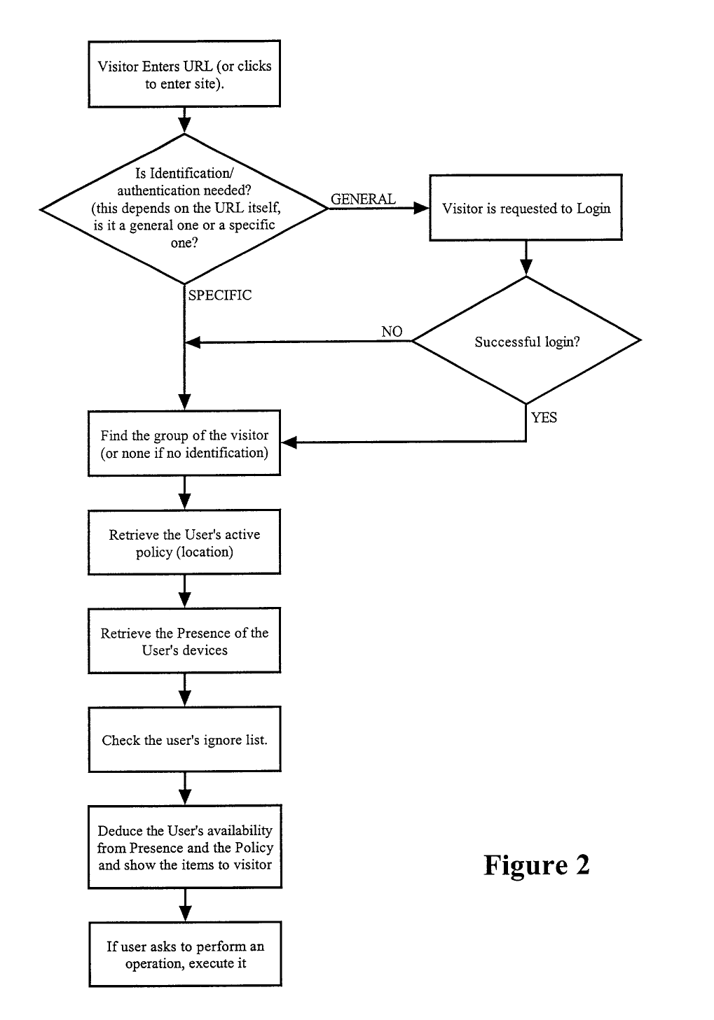

FIG. 2 illustrates system flow diagram of the present invention. In this embodiment, a general or specific URL is used to gain access to a personalized web page. A different URL may be given out to members depending on which group they belong. A more general URL may be given out which requires a login procedure as in FIG. 1. The URL itself can be either:

| A general accessible to all (including non-subscriber user) | |
|---|---|
| (e.g. | ) |

A specific page directed to a specific individual or group (e.g.,

)

Based on the URL or login, a group is determined, the subscriber's policy on access retrieved, subscriber contact devices detected, the subscriber's ignore list retrieved (describer in greater detail hereafter), availability is than deduced from the above information and the set of possible operations enabled to be performed by the visitor is being shown. The visitor can than perform the desired operation that will be routed to the appropriate device.

The personalized web page revealed to a visitor of a specific group comprises various blocks containing combinations of static and dynamic information. Three blocks will be described with respect to the preferred embodiment, however, any number of blocks can be revealed with personalized information without departing form the scope of the present invention.

Login Block

Visitors can identify/authenticate themselves in the subscriber's page so that there might be specific information revealed to them as individuals or as part of a group. Note that the guest page is built in particularly to serve non-subscribers, such as the subscriber's father, giving them the option to communicate with the subscriber, to know his current availability status, and to communicate with him in various possible operations.

Availability Block

A section of the personalized web page includes an availability block to enable visitors to view visitor specific information as to the subscriber's availability. The availability block describes the information the subscriber exposes to the visitor night include:

The group the visitor is part of (if the subscriber exposes this information)

The current policy of the subscriber (if he exposes this information). This policy (usually using ‘location’ terms such as ‘at office’, ‘at home’, ‘in a meeting’) describes, among the information to reveal, the routing policy (for different media types such as audio/video calls or messages) by which the subscriber will be reached (e.g., ‘At Home’ means first try at home than at the cellular, ‘In a meeting’ means receive only text messages, no audio).

The current availability of the subscriber for instantaneous communication—text, e.g., instant messaging (IMS), audio/video, e.g., VoIP phone contact, conference calls or for store and forward communication—text (e.g. e-mail), offline audio/video (voice mail/video mail). The availability is deduced from the current presence of the devices and the subscriber's active policy.

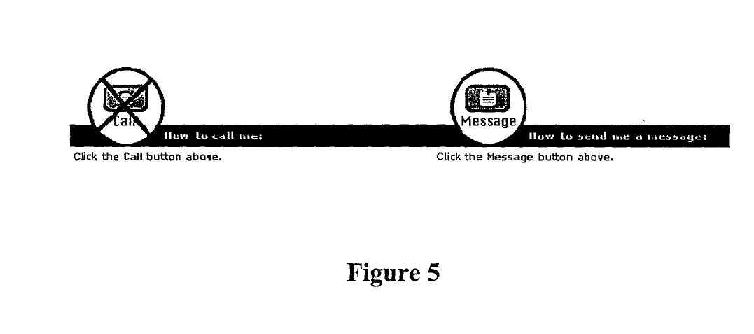

Media types for contact (, Instant messaging, text, audio, video)—FIG. 5

Mixed with static information such as, address, e-mail, office party, name, home phone number, message (personalized)

The availability may be automatically updated (e.g., if the subscriber closes their computer, this action changes their availability).

Possible Operations Block

This area contains the possible operation the visitor can perform in order to communicate with the subscriber. The visitor can perform various operations, such as audio/video calls, instant message, store and forward messages (e-mail), voice mail, etc. . . . The operations will be available in accordance to the subscriber's current availability.

These operations are enables using a plug-in, java applet, link or button that creates a multimedia-over-IP and/or voice-over-IP call to the subscriber or calls a PSTN phone or a Wireless Device, or sends messages to an Instant Messaging Device or sends messages to Pagers or to devices that support SMS, etc. . . . The visitor, when accessing his personal visitor page, may decide to click this button or link, where he/she will be connected (using a voice or multimedia call) to the subscriber or a subscriber service, such as voice-mail, without having to become a subscriber him/herself. The operation will be performed in accordance to the subscriber's active police and the presence of the devices.

Levels of Access

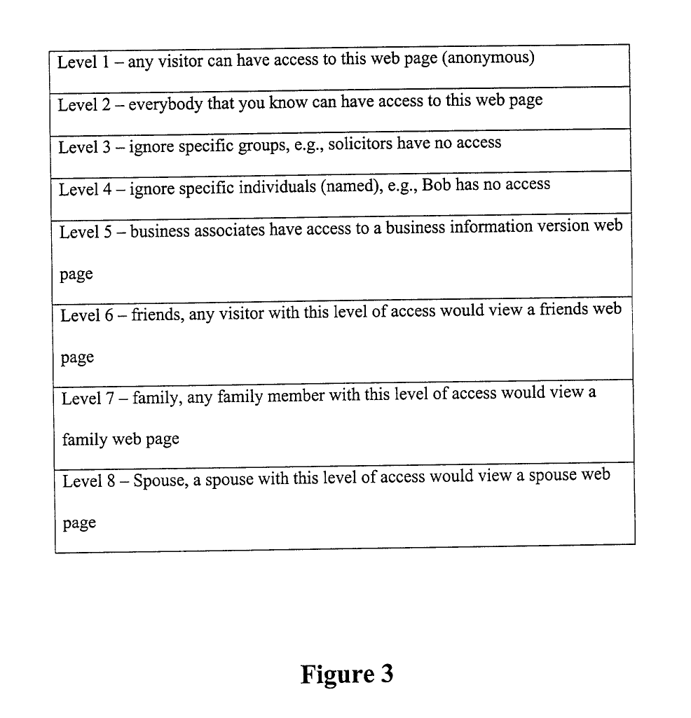

Levels of access are designated by the subscriber's profile. A subscriber designates levels to include or exclude various individuals. For example, the following levels of access, in one embodiment shown in FIG. 3, are designated:

Level 1—any visitor can have access (anonymous) to this web page

Level 2—everybody that you know can have access to this web page

Level 3—ignore specific groups, e.g., solicitors have no access

Level 4—ignore specific individuals (named), e.g., Bob has no access

Level 5—business associates have access to a business information version web page

Level 6—friends, any visitor with this level of access would view a friends web page

Level 7—family, any family member with this level of access would view a family web page

Level 8—Spouse, a spouse with this level of access would view a spouse web page

As can be seen by the examples above, the levels of access are arranged in a hierarchical order of least personal to most personal. If a person is in more than one group, they go to lowest level (hierarchical). Other orderings, however, are considered within the scope of the present invention.

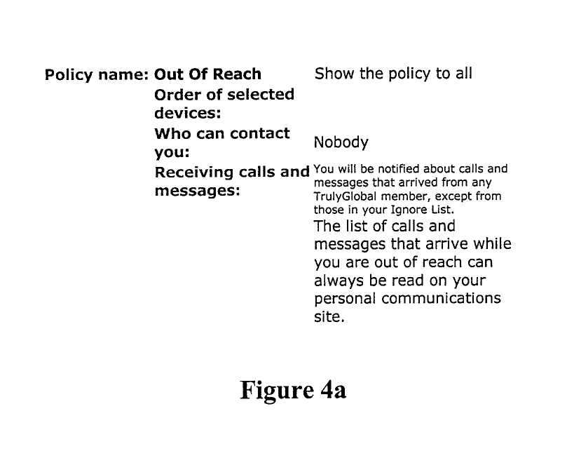

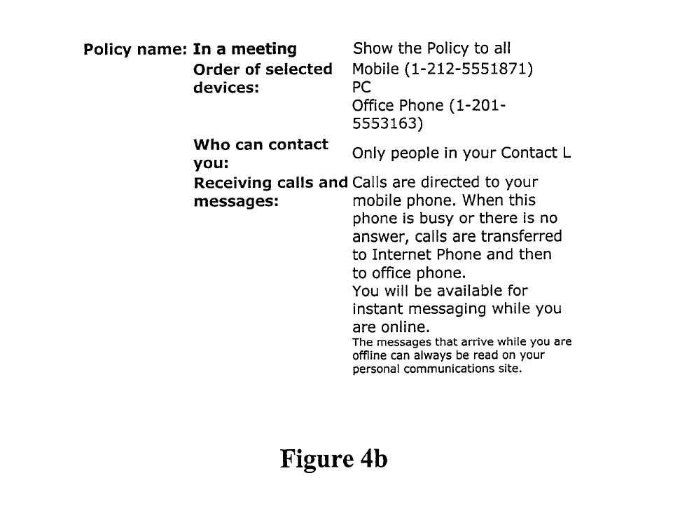

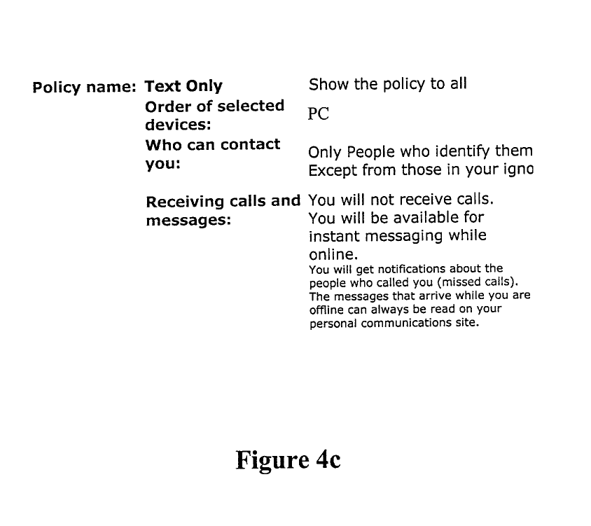

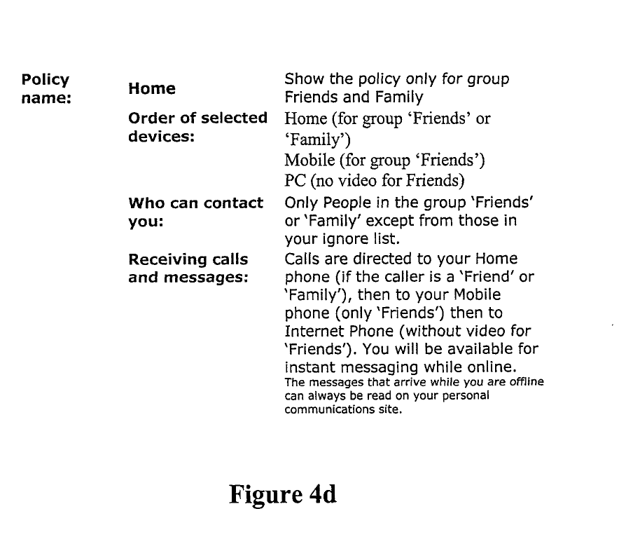

The following are examples of subscriber's policies (FIGS. 4a-4d):

Out of Reach

In the above example of Policy setting no one is able to call or to send a message to that subscriber. Notice that voice mails and non-instantaneous messages can be sent. The presence of devices is irrelevant since there are no devices participating in this policy.

In a Meeting

| | |
|---|---|
| In a meeting | Show this policy to all |
| | Mobile (1-212-5551871) |
| | PC |
| | Office Phone (1-201- |
| | 5553163) |
| | Only people in your Contact L |
| | Calls are directed to your |
| | mobile phone. When this |
| | phone is busy or there is no |
| | answer, calls are transferred |
| | to Internet Phone and then |
| | to office phone. |
| | You will be available for |
| | instant messaging while you |
| | are online. |
| | The messages that arrive while you are |
| | offline can always be read on your |
| | personal communications site. |

If the active policy of the subscriber is as described above, all visitors will be able to see the subscriber is ‘in a meeting’ and all will be able to send him instantaneous messages (if the PC is online). But, only people in the contact list of the subscriber will be able to call him. The call routing starts with the Mobile phone, than the PC (if online) and then the office phone. If the PC is offline—the Presence of the PC is off and the subscriberis unavailable for instantaneous messages.

Text Only

| | |
|---|---|
| Text Only | Show this policy to all |
| | PC |
| | Only People who identify them |
| | Except from those in your igno |
| | You will not receive calls. |
| | You will be available for |
| | instant messaging while |
| | online. |
| | You will get notifications about the |
| | people who called you (missed calls). |
| | The messages that arrive while you are |
| | offline can always be read on your |
| | personal communications site. |

Choosing this setting all visitors can send instantaneous messages to the subscriber (if the presence of the Internet Phone on the PC is online) but none can call him.

Home

| | |
|---|---|
| Home | Show this policy only for group |
| | Friends and Family |
| | Home (for group ‘Friends’ or |
| | ‘Family’) |
| | Mobile (for group ‘Friends’) |
| | PC (no video for Friends) |
| | Only People in the group ‘Friends’ |
| | or ‘Family’ except from those in |
| | your ignore list. |
| | Calls are directed to your Home |
| | phone (if the caller is a ‘Friend’ or |
| | ‘Family’), then to your Mobile |
| | phone (only ‘Friends’) then to |
| | Internet Phone (without video for |
| | ‘Friends’). You will be available for |
| | instant messaging while online. |
| | The messages that arrive while you are offline |
| | can always be read on your personal |
| | communications site. |

A Visitor ‘Friends’

A Visitor who is a member of the subscriber's ‘Friends’ group will see the policy name (home) and will be able to call and to send instant messages (when Internet Phone Online). The routing will be first the Home phone than the Mobile phone and then the Internet Phone (without Video).

A Visitor ‘Family’

A Visitor who is a member of the Family Group will see the policy name and will be able to call and to send messages. However, the routing is different than the ‘Friend’ since the Mobile phone is not presented and because video calls are enabled.

For example: a subscriber may create a “visitor page” specifically for his mother, where the subscriber building the page(s) assigns a specific username and password. His mother, upon accessing the web page, has the capability to call the subscriber using multimedia communications such as Voice-over-IP or send the subscriber information. The page may contain information that is made available only to the subscriber's mother. Such information is made available via the subscriber's policy.

A General Visitor

A general visitor won't see the policy name nor will be able to make calls.

### CONCLUSION

A system and method has been shown in the above embodiments for the effective implementation of personalized visitor pages. Using the present invention, a discernable visitor will only be shown information chosen by the web page subscriber. In addition, the management of various forms of communication, is performed according to a subscriber's wishes. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware and specific levels or web page block content.

The above enhancements for personalized visitor pages and its described functional elements are implemented in various computing environments. For example, the present invention may be implemented on a conventional IBM PC or equivalent, multi-nodal system (e.g. LAN) or networking system (e.g. Internet, WWW, wireless web). All programming, GUIs, display panels and dialog box templates, and data related thereto are stored in computer memory, static or dynamic, and may be retrieved by the subscriber in any of: conventional computer storage, display (i.e. CRT) and/or hardcopy (i.e. printed) formats. The programming of the present invention may be implemented by one of skill in the art of HTML®, XML™, JavaScript™, DHTML® or other web-based programming.

1.A method of enabling selective access to personal information on one or more Internet subscriber's web pages, said method comprising:
providing one or more subscriber web pages, said web pages located on the world wide web or Intranet,
receiving a subscriber profile with respect to at least a first of said web pages,
said subscriber profile including at least access restrictions;
said at least first web page, based on said subscriber profile, comprising personalized combinations of: static information, dynamic information, locator information and communications access;
determining an access level of said visitor, and
personalizing a web page based on a matching of visitor access level with said subscriber profile.

2. A method of enabling selective access to personal information on one or more Internet subscriber's web pages, as per claim 1, wherein said access level is based on any of: password, URL, phone number, code, logging in on a guest web page, and biometrics.

3. A method of enabling selective access to personal information on one or more Internet subscriber's web pages, as per claim 1, wherein said personalized web page comprises at least an availability of the subscriber.

4. A method of enabling selective access to personal information on one or more Internet subscriber's web pages, as per claim 3, wherein said availability comprises one or more of: the current availability of the subscriber for interactive communication or store and forward communication, media types for contact.

5. A method of enabling selective access to personal information on one or more Internet subscriber's web pages, as per claim 4, wherein said store and forward contact comprises one or more of: text, e-mail, voice mail, video mail.

6. A method of enabling selective access to personal information on one or more Internet subscriber's web pages, as per claim 4, wherein said interactive communication comprises one or more of: instant messaging (IMS), audio, video, VoIP phone contact, conference call.

7. A method of enabling selective access to personal information on one or more Internet subscriber's web pages, as per claim 4, wherein said media types include one or more of: HTML or XML interfaced, text, audio, video, conference calls.

8. A method of enabling selective access to personal information on one or more Internet subscriber's web pages, as per claim 1, wherein said personalized web page comprises at least static information mixed with dynamic information.

9. A method of enabling selective access to personal information on one or more Internet subscriber's web pages, as per claim 8, wherein said static information includes one or more of: address, e-mail office party, name, phone number, message (personalized).

10. A method of enabling selective access to personal information on one or more Internet subscriber's web pages, as per claim 8, wherein said dynamic information includes one or more of: subscriber's active policy, availability, and messages.

11. A method of enabling selective access to personal information on one or more Internet subscriber's web pages, as per claim 8, wherein said dynamic information is being updated automatically.

12. A method of enabling selective access to personal information on one or more Internet subscriber's web pages, as per claim 1, wherein said personalized web page comprises any of: a plug-in, java applet, link or button that creates a multimedia-over-IP and/or voice-over-IP call to the subscriber or a PSTN call or a wireless phone call or sends messages to different Instant Messages devices or Sends messages to Pagers or sends SMS.

13. A method of enabling selective access to personal information on one or more Internet subscriber's web pages, as per claim 3, wherein availability is deduced from the current presence of subscriber devices and the current subscriber's policy.

14. A method of personalizing one or more Internet subscriber's web pages based on an access level, said method comprising:
providing one or more web pages, said web pages located on the world wide web or Intranet and comprising at least a first section, said at least first section revealing subscriber availability as represented by selective displaying of any of: static information, dynamic information, locator information;
receiving one or more subscriber profiles defining one or more groups of visitors and associated level of access;
determining an access level of a visitor, and
revealing to said visitor a customized page, including at least said first section, based on a matching of visitor access level with a subscriber profile.

15. A method of personalizing one or more Internet subscriber's web pages based on an access level, as per claim 14, wherein said level of access is based on any of: password, URL, phone number, code, logging in on a guest web page, and biometrics. A method of enabling selective access to personal information on one or more Internet subscriber's web pages, as per claim 1, wherein said personalized web page comprises at least an availability of the subscriber.

16. A method of enabling selective access to personal information on one or more Internet subscriber's web pages, as per claim 15, wherein said availability comprises one or more of: the current availability of the subscriber for interactive communication or store and forward communication, media types for contact.

17. A method of enabling selective access to personal information on one or more Internet subscriber's web pages, as per claim 16, wherein said store and forward communication comprises one or more of: text, e-mail, voice mail, video mail.

18. A method of enabling selective access to personal information on one or more Internet subscriber's web pages, as per claim 16, wherein said interactive communication comprises one or more of: instant messaging (IMS), audio, video, VoIP phone contact, conference call.

19. A method of enabling selective access to personal information on one or more Internet subscriber's web pages, as per claim 16, wherein said media types include one or more of: HTML or XML interfaced, text, audio, video, conference call.

20. A method of enabling selective access to personal information on one or more Internet subscriber's web pages, as per claim 14, wherein said personalized web page comprises at least static information mixed with dynamic information.

21. A method of enabling selective access to personal information on one or more Internet subscriber's web pages, as per claim 20, wherein said static information includes one or more of: address, e-mail, office party, name, phone number, message (personalized).

22. A method of enabling selective access to personal information on one or more Internet subscriber's web pages, as per claim 20, wherein said dynamic information includes one or more of: subscriber's active policy, availability, and messages.

23. A method of enabling selective access to personal information on one or more Internet subscriber's web pages, as per claim 20, wherein said dynamic information is being updated automatically.

24. A method of enabling selective access to personal information on one or more Internet subscriber's web pages, as per claim 14, wherein said personalized web page comprises any of: a plug-in, java applet, link or button that creates a multimedia-over-IP and/or voice-over-IP call to the subscriber or a PSTN call or a wireless phone call or sends messages to different Instant Messages devices or Sends messages to Pagers or sends SMS.

25. A method of enabling selective access to personal information on one or more Internet subscriber's web pages, as per claim 16, wherein availability is deduced from the current presence of subscriber devices and the current subscriber's policy.

26. A rules based method of revealing personal information on one or more Internet subscriber's web pages based on a subscriber policy, said method comprising:
receiving a subscriber's policy, said policy including at least one or more subscriber profiles defining one or more groups of visitors and associated levels of access;
providing one or more web pages, said web pages located on the world wide web or intranet and comprising at least a first section revealing one or more of subscriber availability, current active policy, and static personal information;
determining which group a visitor belongs to, and
assembling a version of said subscriber's web page, including at least said first section, based on a rules based matching of the group the visitor belongs to with said subscriber's policy.

27. A rules based method of revealing personal information on one or more Internet subscriber's web pages based on a subscriber policy, as per claim 26, wherein said level of access is based on any of: password, URL, phone number, code, logging in on a guest web page, and biometrics. A method of enabling selective access to personal information on one or more Internet subscriber's web pages, as per claim 26, wherein said personalized web page comprises at least an availability of the subscriber.

28. A method of enabling selective access to personal information on one or more Internet subscriber's web pages, as per claim 26, wherein said availability comprises one or more of: the current availability of the subscriber for online communication or store and forward communication, media types for contact.

29. A method of enabling selective access to personal information on one or more Internet subscriber's web pages, as per claim 28, wherein said store and forward communication comprises one or more of: text, e-mail, voice mail, video mail.

30. A method of enabling selective access to personal information on one or more Internet subscriber's web pages, as per claim 28, wherein said interactive communication comprises one or more of: instant messaging (IMS), audio, video, VoIP phone contact, conference call.

31. A method of enabling selective access to personal information on one or more Internet subscriber's web pages, as per claim 28, wherein said media types include one or more of: HTML or XML interfaced, text, audio, video, conference call.

32. A method of enabling selective access to personal information on one or more Internet subscriber's web pages, as per claim 26, wherein said personalized web page comprises at least static information mixed with dynamic information.

33. A method of enabling selective access to personal information on one or more Internet subscriber's web pages, as per claim 32, wherein said static information includes one or more of: address, e-mail, office party, name, phone number, message (personalized).

34. A method of enabling selective access to personal information on one or more Internet subscriber's web pages, as per claim 32, wherein said dynamic information includes one or more of: subscriber's active policy, availability, and messages.

35. A method of enabling selective access to personal information on one or more Internet subscriber's web pages, as per claim 32, wherein said dynamic information is being updated automatically.

36. A method of enabling selective access to personal information on one or more Internet subscriber's web pages, as per claim 26, wherein said personalized web page comprises any of: a plug-in, java applet, link or button that creates a multimedia-over-IP and/or voice-over-IP call to the subscriber or a PSTN call or a wireless phone call or sends messages to different Instant Messages devices or Sends messages to Pagers or sends SMS.

37. A method of enabling selective access to personal information on one or more Internet subscriber's web pages, as per claim 28, wherein availability is deduced from the current presence of subscriber devices and the current subscriber's policy.
